(19) United States
(12) Patent Application Publication
(10) Pub. No.: US 2012/0013060 A1
(43) Pub. Date: Jan. 19, 2012

(54) MAGNETIC VISE

(76) Inventor: Wen-Hsuan CHIANG, Taichung City (TW)

(21) Appl. No.: 12/838,959

(22) Filed: Jul. 19, 2010

(51) Int. Cl. B25B 11/00

(52) U.S. Cl. 269/8

(57) ABSTRACT

A magnetic vise comprises a holder, a movable portion, a rotary bar and a magnetic portion. The magnetic portion is located beneath the holder. The holder has a butting surface extended transversely and a boss opposing the butting surface. The rotary bar is a turnable screw bar running through the boss and has a distal end latched on the movable portion to push and pull the movable portion. The movable portion has a clamping surface facing the butting surface. A working piece can be positioned on the holder and attracted by the magnetic force of the magnetic portion to be tightly attached to the holder. The rotary bar can be turned to drive the movable portion against the holder so that the clamping surface is moved towards the butting surface to clamp the working piece without skewing during the clamping process.

### FIELD OF THE INVENTION

The present invention relates to a magnetic vise and particularly to a magnetic vise to clamp a working piece through aid of magnetic force.

### BACKGROUND OF THE INVENTION

A conventional vise, referring to FIG. 1, includes a holder 1, a movable portion 2 and a rotary bar 3. The holder 1 has a butting surface 4 extended transversely and a boss 5 opposing the butting surface 4. The rotary bar 3 is a turnable screw bar running through the boss 5 and has a distal end latched on the movable portion 2 to push or pull the movable portion 2. The movable portion 2 has a clamping surface 6 facing the butting surface 4.

To clamp a working piece (not shown in the drawing), dispose the working piece on the holder 1, turn the rotary bar 3 to drive the movable portion 2 relative to the holder 1 and move the clamping surface 6 towards the butting surface 4 to clamp the working piece.

The aforesaid clamping of the working piece relies on the clamping surface 6 and the butting surface 4 to clamp merely a lower side of the working piece by contact, and the working piece tends to drift slightly upwards. The working piece often has to stricken to be tightly attached to the holder 1. It takes a lot of time and effort, and cannot fully meet user's requirements.

### SUMMARY OF THE INVENTION

Therefore, the primary object of the present invention is to provide a vise with a magnetic portion to prevent a working piece from drifting upwards during clamping.

Another object of the invention is to provide a magnetic portion on a vise for adjusting magnetic force to facilitate positioning and removing of a working piece.

The present invention provides a magnetic vise which comprises a holder, a rotary bar, a movable portion and a magnetic portion. The holder has a butting surface extended transversely and a boss opposing the butting surface. The rotary bar is a turnable screw bar running through the boss and has a distal end latched on the movable portion to push and pull the movable portion. The movable portion has a clamping surface facing the butting surface. The magnetic portion is located beneath the holder and can be a simple electromagnet or permanent magnet to provide magnetic force.

By means of the structure set forth above, the magnetic portion provides magnetic force. When a working piece is disposed on the holder, it is attracted by the magnetic portion and tightly attached to the holder. When the rotary bar is turned to drive the movable portion against the holder, the clamping surface is moved towards the butting surface to clamp the working piece, and the working piece is tightly attached to the holder during the clamping process without skewing or drifting away.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional vise.

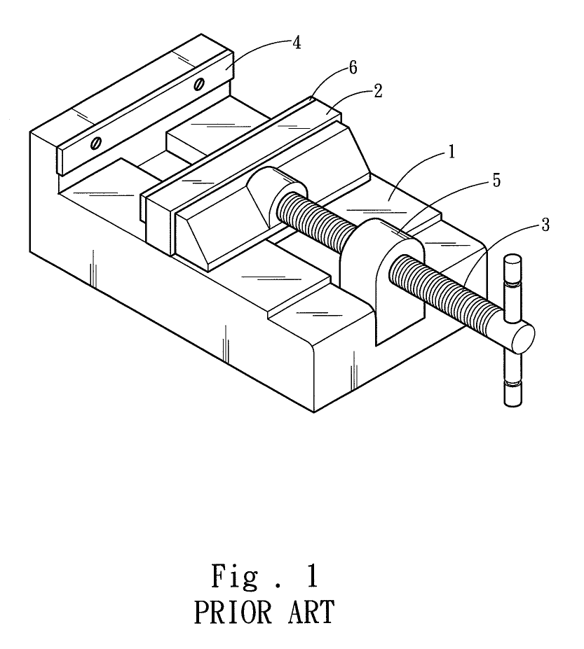

FIG. 2 is a schematic view of the magnetic vise of the invention.

FIG. 3 is a schematic view showing the magnetic portion of the invention in an attractive condition.

### DETAILED DESCRIPTION OF THE PREFERRED EMBODIMENT

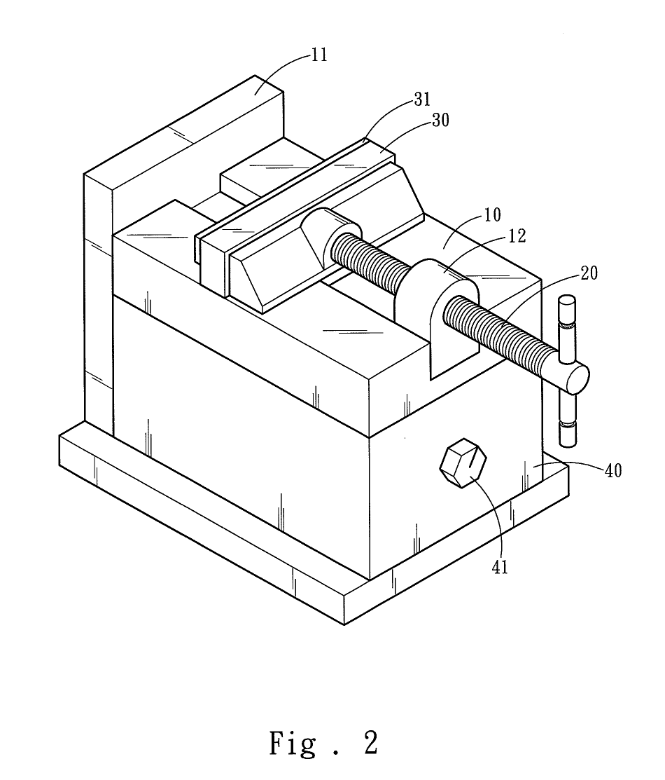

Please refer to FIG. 2, the present invention provides a magnetic vise which comprises a holder 10, a rotary bar 20, a movable portion 30 and a magnetic portion 40. The holder 10 has a butting surface 11 extended transversely and a boss 12 opposing the butting surface 11. The rotary bar 20 is a turnable screw bar running through the boss 12 and has a distal end latched on the movable portion 30 to push and pull the movable portion 30. The movable portion 30 has a clamping surface 31 facing the butting surface 11. The magnetic portion 40 is located beneath the holder 10 and can be a permanent magnet or electromagnet.

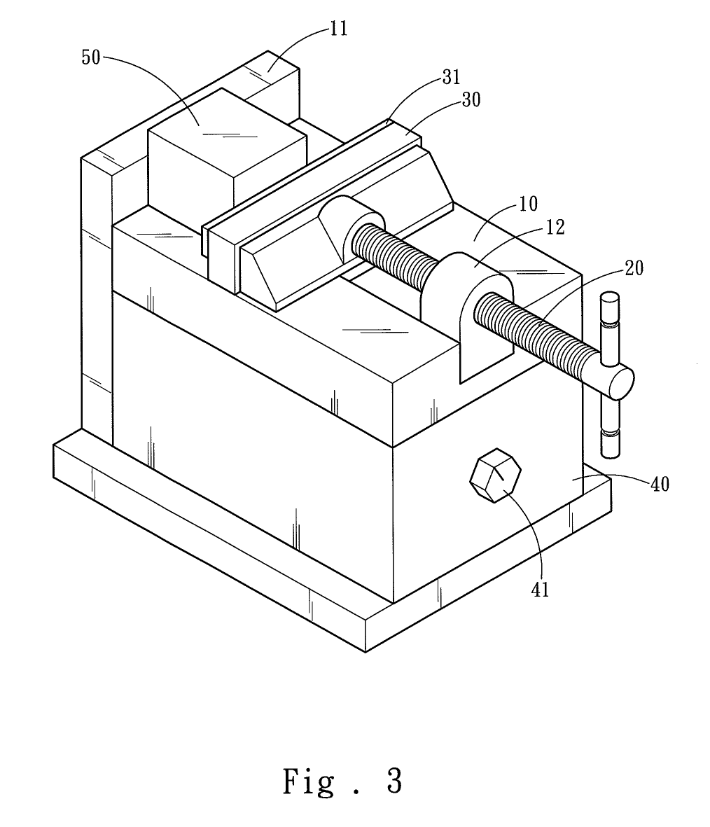

Also referring to FIG. 3, the magnetic portion 40 provides magnetic force and may be inserted by a magnetic rod 41. The magnetic rod 41 can be turned according to requirements to make the magnetic portion 40 either in a demagnetized state (as shown in FIG. 2) or a magnetized state (as shown in FIG. 3). When the magnetic portion 40 is in the demagnetized state, a working piece 50 can be disposed on the holder 10 for positioning, then switch the magnetic portion 40 in the magnetized state to attract the working piece 50. The working piece 50 is tightly attached to the holder 10 through the magnetic force of the magnetic portion 40. Afterward, the rotary bar 20 is turned to drive the movable portion 30 and the clamping surface 31 is moved towards the butting surface 11 to clamp the working piece 50. During the clamping process, the working piece 50 is tightly attached to the holder 10 without drifting away or skewing.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A magnetic vise, comprising:
a holder including a butting surface extended transversely and a boss opposing the butting surface;
a rotary bar which is a turnable screw bar running through the boss;
a movable portion which is latched on the rotary bar to be pushed and pulled and includes a clamping surface facing the butting surface; and
a magnetic portion located beneath the holder.

2. The magnetic vise of claim 1, wherein the magnetic portion is an electromagnet.

3. The magnetic vise of claim 1, wherein the magnetic portion is a permanent magnet.

4. The magnetic vise of claim 1, wherein the magnetic portion is inserted by a magnetic rod which is turned to make the magnetic portion in a magnetized state and a demagnetized state.
